(19) United States
(12) Patent Application Publication
(10) Pub. No.: US 2025/0303841 A1
(43) Pub. Date: Oct. 2, 2025

(54) VEHICLE BASE STRUCTURE

(71) Applicant: Toyota Jidosha Kabushiki Kaisha, Toyota-shi (JP)

(72) Inventor: Katsunori HIGASHIHARA, Toyota-shi (JP)

(73) Assignee: Toyota Jidosha Kabushiki Kaisha, Toyota-shi (JP)

(21) Appl. No.: 19/006,968

(22) Filed: Dec. 31, 2024

(30) Foreign Application Priority Data
Apr. 1, 2024 (JP) 2024-059157

(51) Int. Cl. B60K 1/04

(52) U.S. Cl. CPC B60K 1/04; B60K 2001/0438

(57) ABSTRACT

The vehicle base structure includes a pair of vehicle body structural members extending in the vehicle front-rear direction on both sides in the vehicle width direction of the vehicle, a battery pack disposed between the pair of vehicle body structural members and accommodating one or more battery cells inside the battery case, and an attaching portion protruding inward in the vehicle width direction from the pair of vehicle body structural members on the upper side of the battery pack and capable of mounting the floor panel.

### CROSS-REFERENCE TO RELATED APPLICATION

This application claims priority to Japanese Patent Application No. 2024-059157 filed on Apr. 1, 2024, incorporated herein by reference in its entirety.

### BACKGROUND

### 1. Technical Field

The present disclosure relates to a vehicle base structure.

### 2. Description of Related Art

Japanese Unexamined Patent Application Publication No. 2016-139522 (JP 2016-139522 A) discloses a structure in which a service disconnect switch, for mechanically shutting off a battery high-power circuit by manual operation, is disposed on an upper face of a battery installed under a floor of a vehicle.

### SUMMARY

Now, when an upper case of the battery (battery pack) makes up a vehicle body floor, there are cases in which a load is applied to a battery cell by input from above. In this case, in a battery cell in which a terminal is disposed on an upper side thereof, a floor panel is necessary to suppress short-circuiting when input is applied from above. Thus, when installing battery cells having different terminal arrangement positions on the same platform is desired, this creates a need to separately produce vehicles without the floor panel and vehicles not without the floor panel.

The present disclosure has been made in view of the above circumstances, and an object thereof is to provide a vehicle base structure that enables separately producing vehicles without a floor panel and vehicles not without the floor panel, when installing battery cells having different terminal arrangement positions on the same platform is desired.

A vehicle base structure according to a first aspect includes a pair of vehicle body structural members that extends in a vehicle front-rear direction, on both sides of a vehicle in a vehicle width direction, a battery pack that is disposed between the vehicle body structural members and that accommodates one or more battery cells in a battery case, and attaching portions that each protrude inward in the vehicle width direction from the vehicle body structural members, on an upper side of the battery pack, and that are configured to receive placement of a floor panel.

The vehicle base structure according to the first aspect includes the attaching portions that are on the upper side of the battery pack and that protrude inward in the vehicle width direction from each of the vehicle body structural members, and on which the floor panel can be placed, and accordingly the floor panel can be laid afterwards. This enables the floor panel to be placed when necessary. Accordingly, when installing battery cells having different terminal arrangement positions on the same platform is desired, vehicles without the floor panel and vehicles not without the floor panel can be separately produced.

With a vehicle base structure according to a second aspect, the configuration according to the first aspect further includes two or more cross members that bridge the vehicle body structural members, in which two cross members adjacent to each other in the vehicle front-rear direction are each provided with second attaching portions that protrude toward mutually opposing faces, and that are configured to receive placement of the floor panel.

In the vehicle base structure according to the second aspect, two cross members adjacent to each other in the vehicle front-rear direction, among the two or more cross members bridging the vehicle body structural members, are provided with the second attaching portions protruding toward faces opposing each other and capable of receiving placement of the floor panel. Accordingly, stability when the floor panel is placed can be improved by the second attaching portion.

With a vehicle base structure according to a third aspect, in the configuration according to the first aspect or the second aspect, the attaching portions are integrally fabricated with the vehicle body structural members.

In the vehicle base structure according to the third aspect, the attaching portions are integrally formed with the vehicle body structural members, and accordingly the number of parts and the number of assembly man-hours can be reduced as compared to a structure in which the attaching portions are formed separately from the vehicle body structural members.

With a vehicle base structure according to a fourth aspect, in the configuration according to the first aspect or the second aspect, the attaching portions are fastened to the vehicle body structural members by a fastening member that is configured to be fastened from one side.

In the vehicle base structure according to the fourth aspect, the attaching portions are fastened to the vehicle body structural members by the fastening members that can be fastened from one side, and accordingly the attaching portions can be fastened from the inner side of the vehicle body structural members. Thus, workability in attaching the attaching portions can be improved.

With a vehicle base structure according to a fifth aspect, in the configuration according to any one of the first to fourth aspects, the attaching portions are fabricated of a letter L shaped member including an attaching face for attaching to the vehicle body structural members, and a placement receiving face for receiving placement of the floor panel.

In the vehicle base structure according to the fifth aspect, the attaching portions are made up of the letter L shaped members including the attaching face for attaching to the vehicle body structural members and the placement receiving face for receiving placement of the floor panel, and accordingly the attaching portion has a simple structure, whereby costs can be reduced.

As described above, the vehicle base structure according to the present disclosure is advantageous in that, when installing battery cells having different terminal arrangement positions on the same platform is desired, vehicles without the floor panel and vehicles not without the floor panel can be separately produced.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an exploded perspective view schematically showing a part of a vehicle base structure according to an embodiment of the present disclosure;

FIG. 2 is a cross-sectional view schematically illustrating a state cut along line 2-2 of FIG. 1 in a non-disassembled state;

FIG. 3 is an enlarged cross-sectional view showing a main part of FIG. 2 in an enlarged manner;

FIG. 4 is an enlarged sectional view of a main part corresponding to FIG. 3 showing a modification of the attaching portion;

FIG. 5 is a cross-sectional view schematically illustrating a vehicle base structure of a vehicle that is not a conventional floor panel-less structure;

FIG. 6 is a cross-sectional view schematically showing a vehicle base structure of a conventional floor panel-less vehicle; and

FIG. 7 is a cross-sectional view for explaining a problem in a conventional floor panel-less vehicle.

### DETAILED DESCRIPTION OF EMBODIMENTS

A vehicle base structure 10 according to an embodiment of the present disclosure will be described with reference to the drawings.

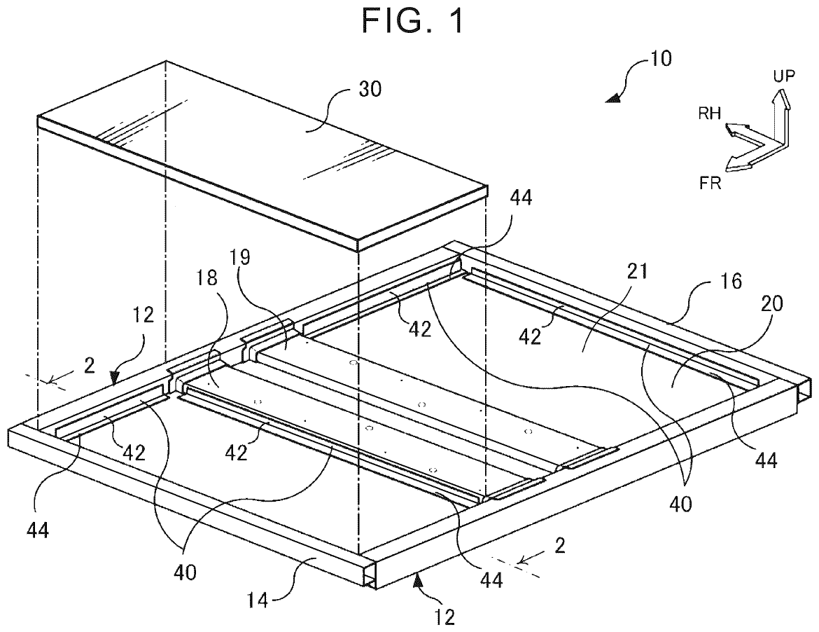

FIG. 1 is an exploded perspective view schematically showing a part of a vehicle base structure 10 according to an embodiment. Note that the arrow FR, the arrow UP, and the arrow RH in the drawing respectively indicate the vehicle front direction, the vehicle upper direction, and the vehicle right direction in the vehicle to which the vehicle base structure 10 is applied. In the following description, when the front, rear, up, down, and left and right directions are used without special mention, the front and rear directions in the vehicle front-rear direction, the up and down directions in the vehicle up-down direction, and the left and right directions in the vehicle left-right direction (width direction) are respectively indicated. In addition, in the drawing, an arrow IN indicates a vehicle widthwise direction inner side or a vehicle front-rear direction inner side in a vehicle to which the vehicle base structure 10 is applied.

As shown in FIG. 1, the vehicle base structure 10 of the present embodiment includes a pair of rockers 12 extending in the vehicle front-rear direction on both sides in the vehicle width direction of the vehicle, and a battery pack 20 disposed between the pair of rockers 12. Further, the vehicle base structure 10 includes an attaching portion 40 on which the floor panel 30 can be placed on the upper side of the battery pack 20.

Further, the vehicle base structure 10 includes a front cross member 14 that is provided at a front end portion of the pair of rockers 12 and to which a front module (not shown) constituting a front portion of the vehicle is joined. Further, the vehicle base structure 10 includes a rear cross member 16 that is provided at the rear end portions of the pair of rockers 12 and to which a rear module (not shown) constituting the rear portion of the vehicle is joined. The front cross member 14 and the rear cross member 16 are respectively installed in a pair of rockers 12.

Further, the vehicle base structure 10 includes a first cross member 18 and a second cross member 19 between the front cross member 14 and the rear cross member 16 and at a center portion of the rocker 12 in the vehicle front-rear direction. The first cross member 18 and the second cross member 19 extend in the vehicle width direction, respectively, and are installed between the pair of left and right rockers 12. In addition, a vehicle seat of a front seat (not shown) is attached to the first cross member 18 and the second cross member 19.

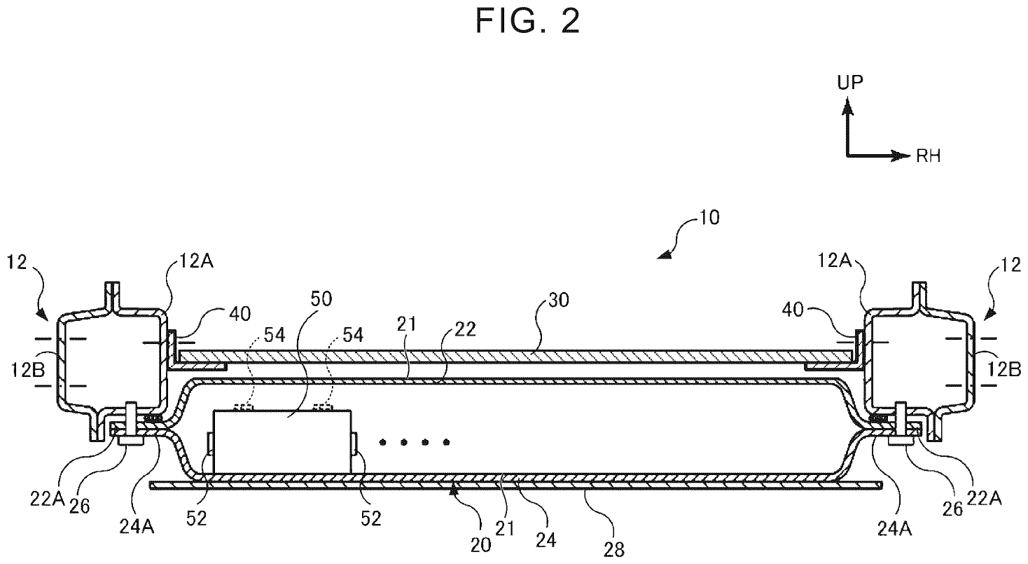

FIG. 2 is a cross-sectional view schematically illustrating a state cut along line 2-2 of FIG. 1 in a non-disassembled state. As shown in FIG. 2, the rocker 12 is a vehicle body structural member formed in a substantially rectangular closed cross-section. The rocker 12 has a rocker inner panel 12A located on the inside in the vehicle width direction and a rocker outer panel 12B located on the outside in the vehicle width direction. The rocker inner panel 12A and the rocker outer panel 12B are joined to each other at respective upper and lower edges, and a closed space extending in the front-rear direction is formed inside the rocker 12. Note that an energy-absorbing material or the like may be disposed in a closed cross section formed by the rocker inner panel 12A and the rocker outer panel 12B.

The battery pack 20 is provided in a lower portion of the vehicle, and one or more battery cells 50 are accommodated therein. The battery pack 20 includes a battery case 21 that includes an upper case 22 and a lower case 24 and is formed in a substantially box shape. The upper case 22 is formed in a substantially hat shape in which the vehicle lower side is opened in a cross-sectional view viewed from the vehicle front-rear direction. An upper-side flange 22A is formed at both vehicle-width-direction end portions of the upper case 22 so as to be superimposed on the lower surfaces of the left and right rockers 12.

The lower case 24 is formed in a substantially hat shape in which the vehicle upper side is opened in a cross-sectional view viewed from the vehicle front-rear direction. At both vehicle-width-direction end portions of the lower case 24, a lower-side flange 24A is formed to be superimposed on the upper-side flange 22A of the upper case 22. The upper-side flange 22A and the lower-side flange 24A are mechanically fastened to the rocker 12 by inserting fasteners 26 such as bolts from the lower side. Note that the battery pack 20 may be configured by a battery cover that covers the upper portion of the battery cell 50. In this case, instead of the lower case 24, a member that supports the battery cell 50 from below may be provided.

Further, a metal panel member 28 as a lower load transmission member is provided on the vehicle lower side of the battery pack 20. The panel member 28 extends in the vehicle width direction and the vehicle front-rear direction. The panel member 28 is formed in a substantially flat plate shape so as to cover the battery pack 20 from the vehicle lower side.

A plurality of battery cells 50 are arranged side by side in the vehicle width direction and the vehicle front-rear direction, and each battery cell 50 is, for example, a lithium ion battery. In the present embodiment, as shown in FIG. 2 as an example, the battery cells 50 are provided with the terminals 52 in the vehicle width direction or the vehicle front-rear direction, rather than on the vehicle upper side. In the technology of the present disclosure, instead of the terminal 52, a terminal 54 disposed on the vehicle upper side as indicated by a dotted line in the drawing may be provided.

The attaching portion 40 is formed by an L-shaped member as an example, and is formed in an elongated shape. In the present embodiment, as shown in FIG. 1 as an example, in the attaching portion 40, four attaching portions 40 are attached to each of the vehicle front side of the first cross member 18 and the vehicle rear side of the second cross member 19. Specifically, at each of the vehicle front side and the vehicle rear side, the attaching portion 40 is disposed and attached so as to extend in the vehicle front-rear direction inside the pair of rockers 12 in the vehicle width direction.

Further, the attaching portion 40 is attached to the rear surface of the front cross member 14, the front surface of the rear cross member 16, the front surface of the first cross member 18, and the rear surface of the second cross member 19 so as to extend in the vehicle width direction, respectively.

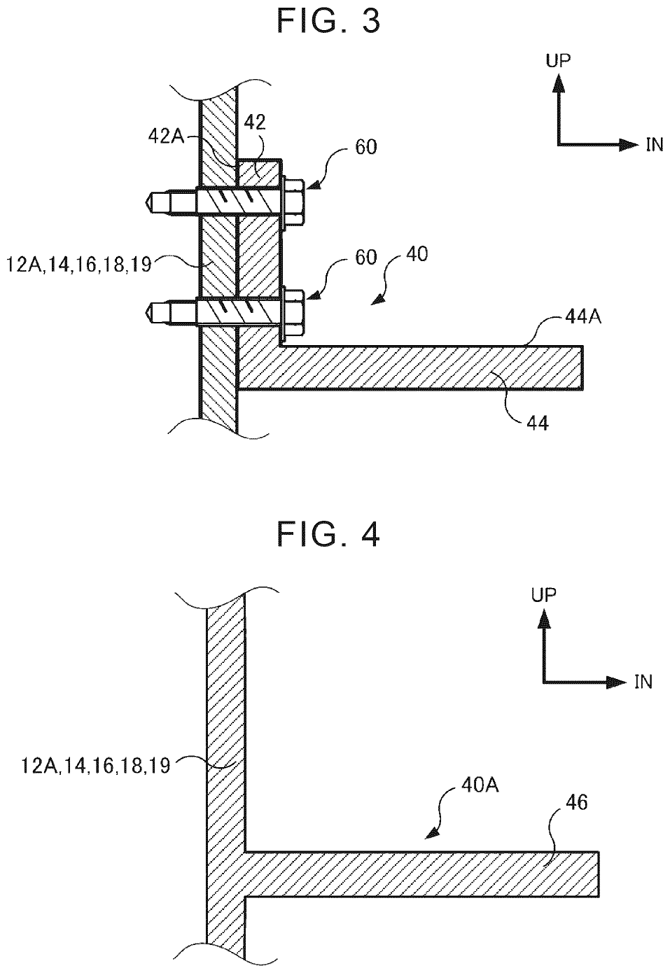

FIG. 3 is an enlarged cross-sectional view showing a main part of FIG. 2 in an enlarged manner. As shown in FIG. 3, the attaching portion 40 includes one end portion 42 having an attaching face 42A to any one attachment-receiving member of the rocker inner panel 12A, the front cross member 14, the rear cross member 16, the first cross member 18, and the second cross member 19 of the rocker 12. Further, the attaching portion 40 is provided with the other end portion 44 that extends perpendicularly from the end portion of the one end portion 42 and has a placement receiving face 44A of the floor panel 30.

One end portion 42 of the attaching portion 40 is fastened to the attachment-receiving member by a fastening member 60 that can be fastened from one side. Specifically, in the present embodiment, the one end portion 42 is fastened to the rocker inner panel 12A of the rocker 12 from the vehicle-width-direction inner side by the fastening member 60. Further, the one end portion 42 is fastened to the rear cross member 16 and the first cross member 18 from the vehicle front side by the fastening member 60. Further, the one end portion 42 is fastened to the front cross member 14 and the second cross member 19 from the vehicle rear side by the fastening member 60.

In the present embodiment, as an example, as shown in FIG. 3, the one end portion 42 is fastened to the attachment-receiving member by the fastening member 60 at two positions in the vehicle up-down direction and at a plurality of positions set at predetermined intervals in the longitudinal direction of the one end portion 42. As the fastening member 60, any fastening member can be used as long as it can be fastened by construction from one side, or a known fastening member can be used.

Further, as shown in FIG. 3, in the attaching portion 40 fastened to the pair of rockers 12 by the fastening member 60, the other end portion 44 is provided to protrude toward the vehicle width direction inner side. Further, in the attaching portion 40 which is fastened to the front cross member 14 and the first cross member 18 which are two cross members adjacent to each other in the vehicle front-rear direction by the fastening member 60, the other end portion 44 is projected toward the surface facing each other. Similarly, in the attaching portion 40 fastened to the rear cross member 16 and the second cross member 19 by the fastening member 60, the other end portion 44 is protruded toward the surface facing each other.

As shown in FIG. 1, in the vehicle on which the vehicle base structure 10 of the present embodiment is mounted, the floor panel 30 is placed on the upper surfaces of the four other end portions 44 protruding from the respective attachment-receiving members on the vehicle front side relative to the first cross member 18, as necessary. Further, although not shown, on the upper surface of the four other end portions 44 projecting from the respective attachment-receiving members on the vehicle rear side than the second cross member 19, the floor panel 30 is placed as necessary. The floor panel 30 is a member that constitutes the floor surface of the vehicle cabin, and is, for example, a rectangular plate member.

In the present embodiment, as described above, the rocker 12 and the attaching portion 40 are formed separately, but the rocker 12 and the attaching portion 40 may be formed integrally. FIG. 4 is an enlarged cross-sectional view of a main part corresponding to FIG. 3 showing a modification of the attaching portion 40. As shown in FIG. 4, the attaching portion 40A of the modification is constituted by a protruding portion 46 that protrudes in an elongated shape from the attachment-receiving member of the rocker inner panel 12A, the front cross member 14, the rear cross member 16, the first cross member 18, and the second cross member 19 of the rocker 12. Specifically, the attaching portions 40A provided in the pair of rockers 12 are provided with projecting portions 46 projecting inward in the vehicle widthwise direction. Further, the attaching portion 40A provided on each of the front cross member 14 and the first cross member 18, projecting portion 46 toward the surface facing each other is provided. Similarly, the attaching portions 40 provided on the rear cross member 16 and the second cross member 19 are provided with projecting portions 46 projecting toward surfaces facing each other.

### Operations and Effects

Next, the operation and effect of the present embodiment will be described.

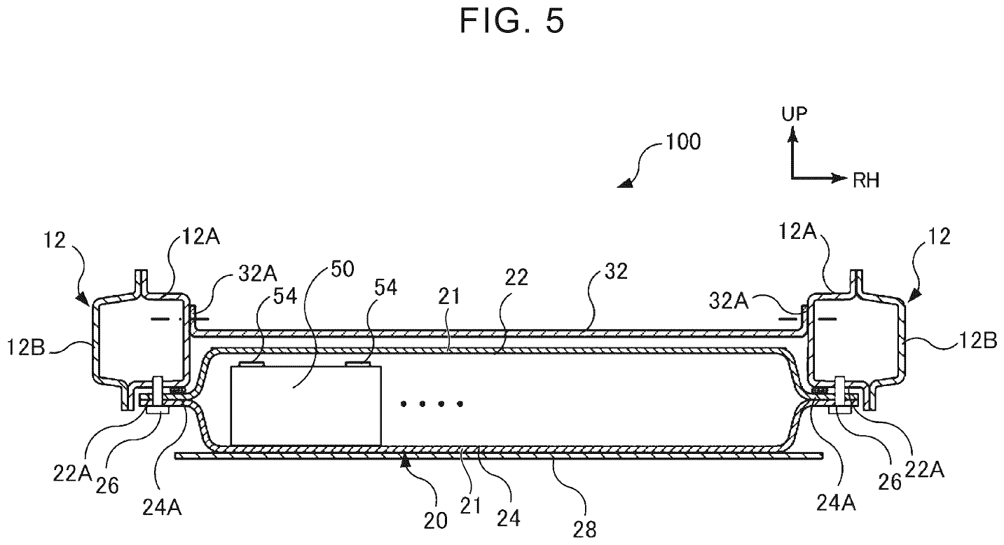

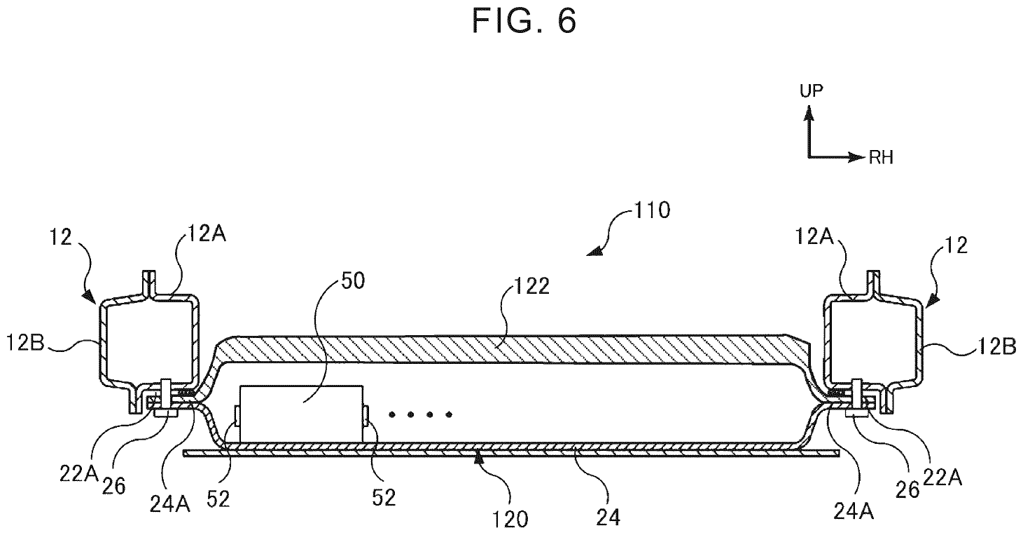

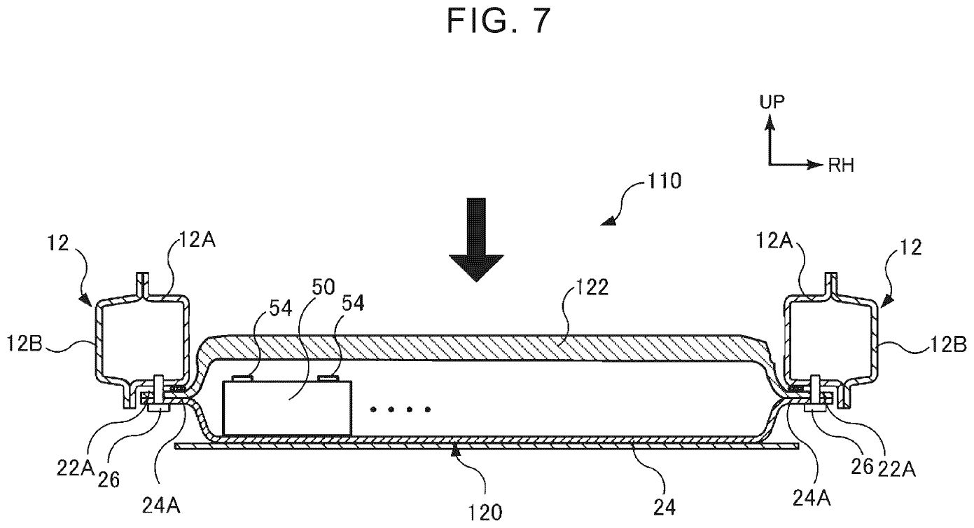

FIG. 5 is a cross-sectional view schematically illustrating a vehicle base structure of a vehicle that is not a conventional floor panel-less vehicle. FIG. 6 is a cross-sectional view schematically showing a vehicle base structure of a conventional floor panel-less vehicle. FIG. 7 is a cross-sectional view for explaining a problem in a conventional floor panel-less vehicle. In each of the drawings, in the above-described embodiments, the same components as those shown in FIG. 2 are denoted by the same reference numerals, and description thereof will be omitted.

As shown in FIG. 5, conventionally, a vehicle (hereinafter, referred to as a floor panel-mounted vehicle) 100 on which the floor panel 32 is mounted is disposed above the upper case 22 of the battery pack 20 as an example. The floor panel 32 includes flange portions 32A bent upward at both end portions thereof, and the flange portions 32A are joined to the rocker inner panel 12A of the rocker 12. In FIG. 5, the battery cell 50 accommodated in the battery pack 20 is provided with a terminal 54 on the vehicle upper side, but instead of the terminal 54, it is also possible to provide a terminal arranged in the vehicle width direction or the vehicle front-rear direction.

On the other hand, in recent years, a vehicle (hereinafter, referred to as a floor panel-less vehicle) has been known which adopts a structure in which a floor panel is removed and an upper surface of a battery pack is made to function as a floor panel in order to reduce the number of parts and expand a vehicle cabin. As illustrated in FIG. 6, in the floor panel-less vehicle 110, the upper case 122 of the battery pack 120 functions as a floor panel. In the floor panel-less vehicle 110, the battery cells 50 accommodated in the battery pack 120 are provided with terminals 52 in the vehicle width direction or the vehicle front-rear direction.

However, as shown in FIG. 7, in the floor panel-less vehicle 110, a load may be applied to the battery cell 50 by an input from above indicated by a black arrow in the drawing. In this case, for example, in a case where the battery cell 50 in which the terminal 54 is disposed on the upper side of the vehicle is used, the floor panel 32 as shown in FIG. 5 is required to suppress a short circuit when an input is input from above. Therefore, when a battery cell 50 having a different terminal arrangement position is desired to be mounted on the same platform, it is necessary to separate a vehicle (floor panel-less vehicle) that does not include a floor panel and a vehicle (floor panel-mounted vehicle) that does not include a floor panel.

Therefore, in the vehicle base structure 10 according to the present embodiment, an attaching portion 40 is provided on the upper side of the battery pack 20 so as to protrude from the pair of rockers 12 toward the vehicle width direction inner side and to be able to mount the floor panel 30. Therefore, the floor panel 30 can be installed later by the attaching portion 40. This makes it possible to mount the floor panel 30 when necessary. Therefore, in a case where it is desired to mount the battery cells 50 having different terminal arrangement positions on the same platform, it is possible to make a vehicle without a floor panel and a vehicle without a floor panel.

Further, in the vehicle base structure 10 according to the present embodiment, two cross members (the front cross member 14 and the first cross member 18, and the second cross member 19 and the rear cross member 16) adjacent to each other in the vehicle front-rear direction among two or more cross members installed in the pair of rockers 12 are provided so as to protrude toward surfaces facing each other. The vehicle base structure 10 includes an attaching portion 40 on which the floor panel 30 can be placed. Therefore, the attaching portion 40 can enhance stability when the floor panel 30 is placed.

Further, in the vehicle base structure 10 according to the present embodiment, since the attaching portion 40 is fastened to the attachment-receiving member by the fastening member 60 that can be fastened from one side, the attaching portion 40 can be fastened from the inside of the attachment-receiving member. Therefore, workability in attaching the attaching portion 40 can be improved.

In addition, in the vehicle base structure 10 according to the present embodiment, the attaching portion 40 is formed of an L-shaped member including the attaching face 42A to the attachment-receiving member and the placement receiving face 44A of the floor panel 30. Therefore, cost can be reduced by adopting a simple structure of the attaching portion 40.

Further, in the above-described modification, since the attaching portion 40A is integrally formed with the attachment-receiving member, the number of components and the number of assembling steps can be reduced as compared with a configuration in which the attaching portion 40 is formed separately from the attachment-receiving member.

### Supplementary Explanation

In the above-described embodiment, the attaching portion 40 is formed of an L-shaped member, but the present disclosure is not limited to this. For example, the attaching portion may be a cylindrical member or the like protruding from the attachment-receiving member. That is, the shape of the attaching portion is not limited as long as the floor panel 30 can be placed.

Further, in the above-described embodiment, the attaching portion 40 is attached to the attachment-receiving member by the fastening member 60, but the present disclosure is not limited thereto, and may be joined by welding or may be attached by other means.

Further, the configuration of the present disclosure is not limited to the above-described embodiment, and the configuration can be changed as appropriate as long as the problem can be solved.

What is claimed is:

1. A vehicle base structure, comprising:
a pair of vehicle body structural members that extends in a vehicle front-rear direction, on both sides of a vehicle in a vehicle width direction;
a battery pack that is disposed between the vehicle body structural members and that accommodates one or more battery cells in a battery case; and
attaching portions that each protrude inward in the vehicle width direction from the vehicle body structural members, on an upper side of the battery pack, and that are configured to receive placement of a floor panel.

2. The vehicle base structure according to claim 1, further comprising:
two or more cross members that bridge the vehicle body structural members, wherein
two cross members adjacent to each other in the vehicle front-rear direction are each provided with second attaching portions that protrude toward mutually opposing faces, and that are configured to receive placement of the floor panel.

3. The vehicle base structure according to claim 1, wherein the attaching portions are integrally fabricated with the vehicle body structural members.

4. The vehicle base structure according to claim 1, wherein the attaching portions are fastened to the vehicle body structural members by a fastening member that is configured to be fastened from one side.

5. The vehicle base structure according to claim 1, wherein the attaching portions are fabricated of a letter L shaped member including an attaching face for attaching to the vehicle body structural members, and a placement receiving face for receiving placement of the floor panel.
